(19) United States
(12) Patent Application Publication
(10) Pub. No.: US 2026/0328049 A1
(43) Pub. Date: Oct. 22, 2026

(54) MODULAR SECURITY SHELTER

(71) Applicant: SAFE CAVE, LLC, TROPHY CLUB, TX (US)

(72) Inventor: CHAD MORRILL, TROPHY CLUB, TX (US)

(21) Appl. No.: 19/646,526

(22) Filed: Apr. 13, 2026

Related U.S. Application Data
(60) Provisional application No. 63/787,431, filed on Apr. 11, 2025.

(51) Int. Cl. E06B 5/11; E04B 1/343; E06B 5/16

(52) U.S. Cl. CPC E06B 5/11; E04B 1/34321; E06B 5/162

(57) ABSTRACT

A secure shelter built from structural panels having double bends at each end to provide multiple surfaces for engagement with other structural panels. The secure shelter may also include a secure, vault-like door having a single-action locking mechanism and integrated ventilation system.

### CITATION TO PRIOR APPLICATIONS

The present application claims priority to U.S. Provisional Application No. 63/787,431, titled “MODULAR SECURITY SHELTER” and filed on Aprill 11, 2025, which is, along with all references therein, entirely incorporated by reference herein.

### BACKGROUND OF THE INVENTION

### Background and Invention Summary

Conventional security shelters rely on use of specialized ceiling, corner, and wall panels to effectuate any degree of modularity. The use of these specialized components eliminates full modularity wherein any component piece would function as any segment of the security shelter.

A modular security shelter in accordance with embodiments of present disclosure provides a fully sealed, integrated vault door system designed for use in conjunction, and integrated, with fully modular structural panels. This system combines advanced sealing mechanisms, impact resistance, and secure access features for enhanced protection and customization in secure spaces.

Embodiments of the present disclosure feature the only modular secure room to be designed as a completely integrated system. There are secure, vault doors readily available in the market. There are also partially modular shelters conventionally available. There is no conventional shelter that leverages the advantages of both. This shortcoming is the result of the conventional design philosophies relied upon in such shelters. The present disclosure provides a fully integrated and engineered design bringing complete modularity and security together for the residential market.

Other aspects, embodiments, and features of the present disclosure will become apparent from the following Detailed Description when considered in conjunction with the accompanying Figures.

### BRIEF DESCRIPTION OF DRAWINGS

The preceding aspects and many of the attendant advantages of the present disclosure will become more readily appreciated by reference to the following figures and description of various exemplary embodiments. The drawings briefly described below are presented for ease of explanation and do not limit the scope of any claimed subject matter.

FIG. 1A is a front perspective view of a modular security shelter in accordance with embodiments of the present disclosure.

FIG. 1B is a front view of a modular security shelter in accordance with embodiments of the present disclosure.

FIG. 2A is a side view of a secure door in accordance with embodiments of the present disclosure.

FIG. 2B is a side view of a locking assembly in accordance with embodiments of the present disclosure.

FIG. 2C is a perspective, cutaway rear view of a secure door in accordance with embodiments of the present disclosure.

FIG. 3A is a front view of an interior-facing lock driver in accordance with embodiments of the present disclosure.

FIG. 3B is a front view of an exterior-facing lock driver in accordance with embodiments of the present disclosure.

FIG. 4 is a front view of a secure door in accordance with embodiments of the present disclosure.

FIG. 5A is a rear view of a secure door in accordance with embodiments of the present disclosure.

FIG. 5B is a front view of a ventilation assembly of a secure door in accordance with embodiments of the present disclosure.

FIG. 5C is a front perspective of a secure door in accordance with embodiments of the present disclosure.

FIG. 5D is a rear perspective of a secure door in accordance with embodiments of the present disclosure.

FIG. 6A is a front perspective, cutaway view of a ventilation assembly of a secure door in accordance with embodiments of the present disclosure.

FIG. 6B is a front perspective, cutaway view of a ventilation assembly of a secure door in accordance with embodiments of the present disclosure.

FIG. 6C is a perspective, cutaway view of a ventilation assembly of a secure door in accordance with embodiments of the present disclosure.

FIG. 7A is a front view of a secure door in accordance with embodiments of the present disclosure.

FIG. 7B front, cutaway view of a secure door in accordance with embodiments of the present disclosure.

FIG. 8A is a front perspective view of a modular security shelter in accordance with embodiments of the present disclosure.

FIG. 8B is a rear perspective view of a structural panel in accordance with embodiments of the present disclosure.

FIG. 8C is a rear perspective view of a structural panel in accordance with embodiments of the present disclosure.

FIG. 8D is an interior, perspective view of a prior art shelter.

FIG. 8E is an interior perspective view of a security shelter in accordance with embodiments of the present disclosure.

FIG. 8F is a rear view of a structural panel in accordance with embodiments of the present disclosure.

FIG. 8G is a front perspective view of a structural panel in accordance with embodiments of the present disclosure.

FIG. 8H is a front view of a structural panel in accordance with embodiments of the present disclosure.

FIG. 81 is a side perspective, cutaway view of a security shelter in accordance with embodiments of the present disclosure.

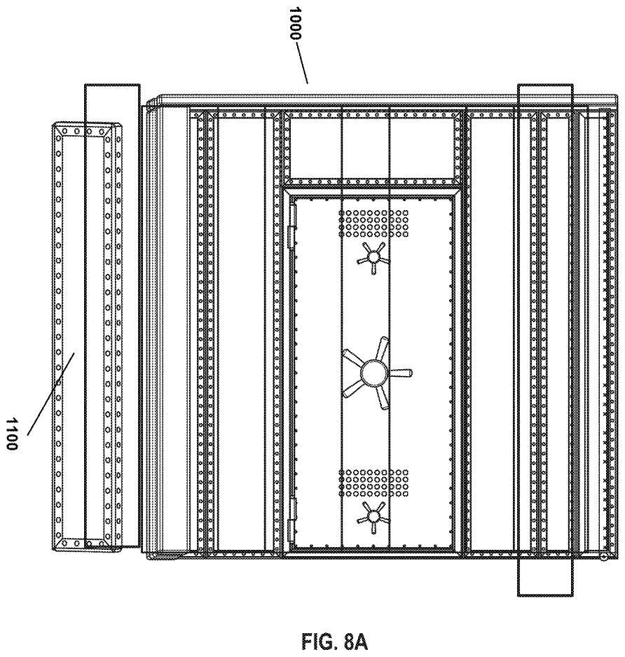

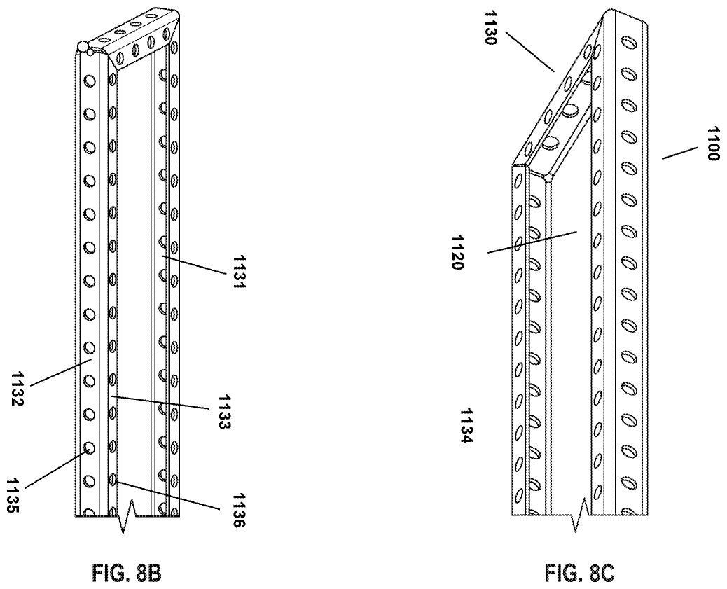

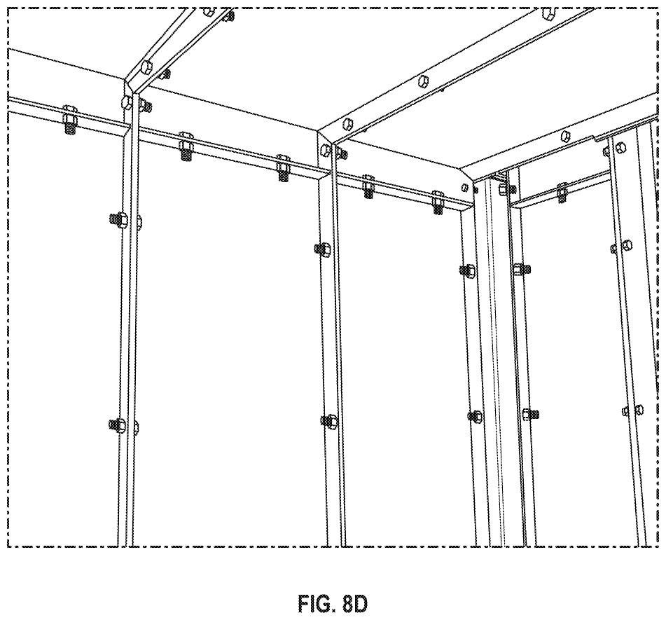

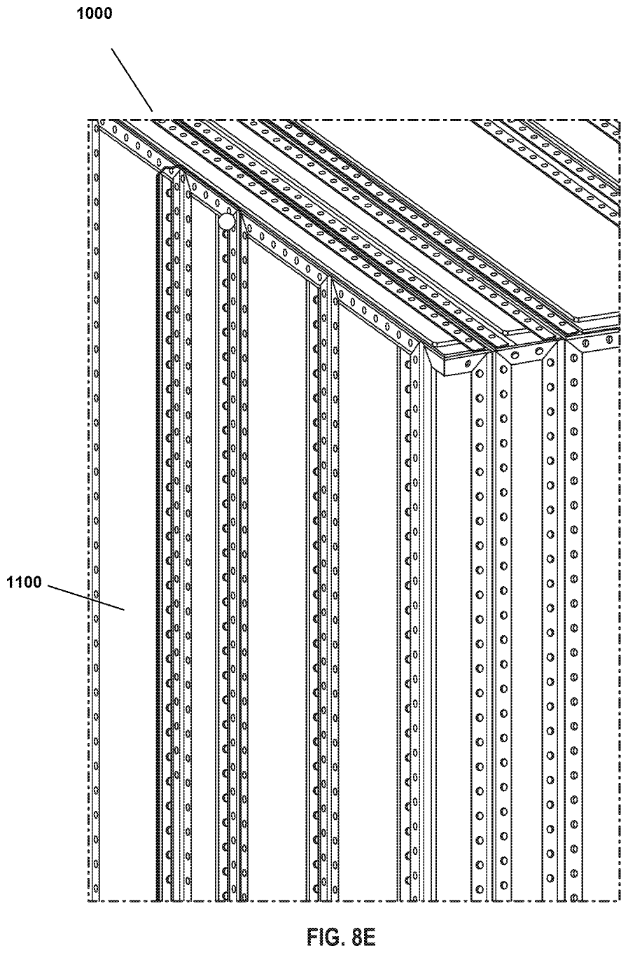

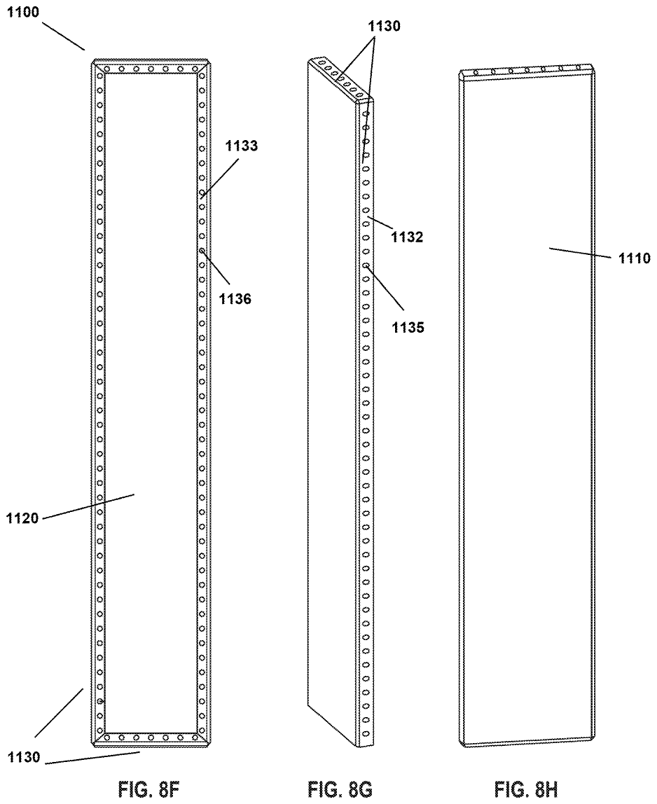

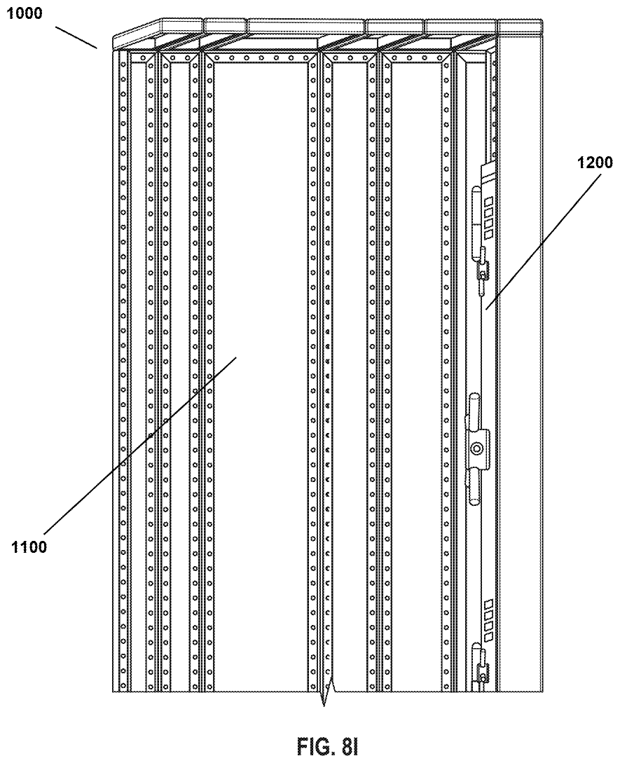

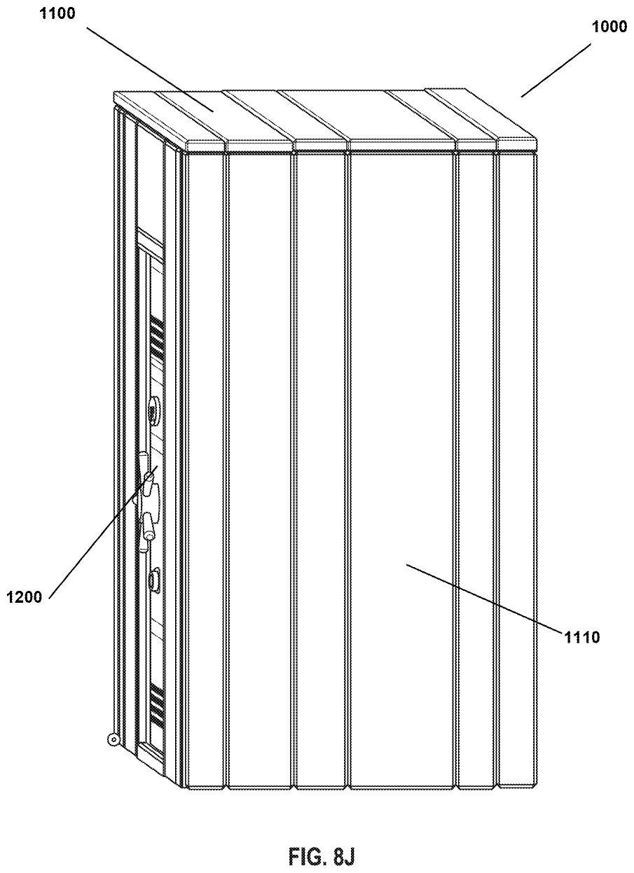

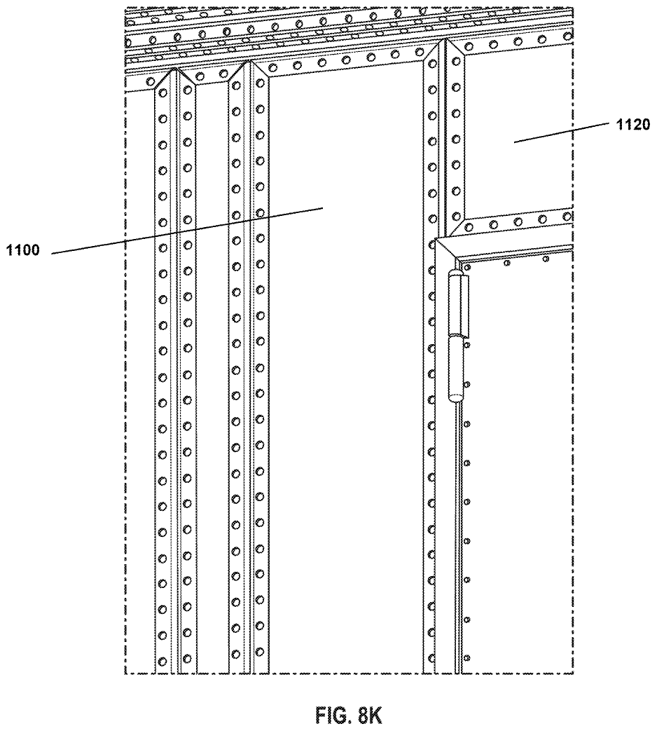

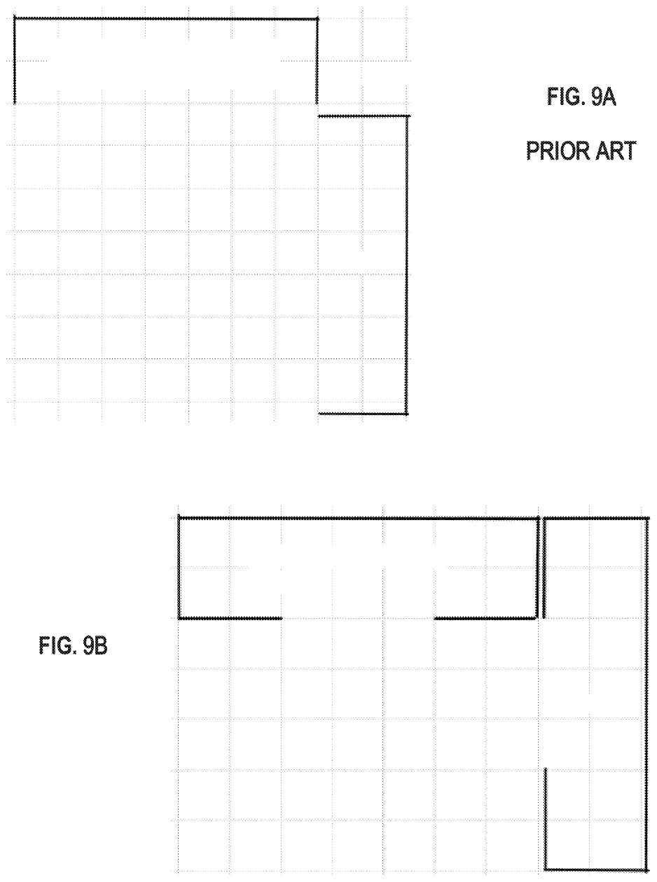

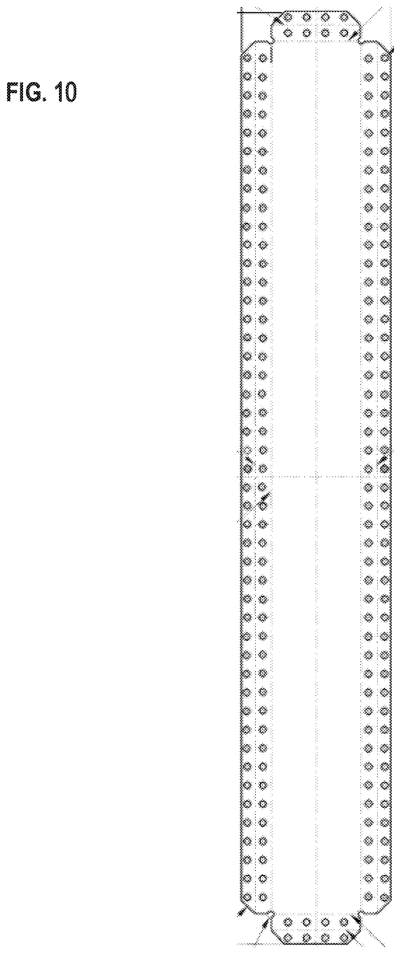

FIG. 8J is a side perspective view of a security shelter in accordance with embodiments of the present disclosure.

FIG. 8K is an interior perspective view of a security shelter in accordance with embodiments of the present disclosure.

FIG. 9A is a diagrammatic view of a prior art, partially modular shelter.

FIG. 9B is a diagrammatic view of a fully modular shelter in accordance with embodiments of the present disclosure.

FIG. 10 is a top view of a pattern for a structural panel in accordance with embodiments of the present disclosure.

### DETAILED DESCRIPTION

Embodiments of a modular security shelter 1000 in accordance with the present disclosure comprises a plurality of structural panels 1100 and a secure door 1200.

Structural panels 1100 may be of a double-bend panel design capable of accommodating differentiated vault-style, single-action opening doors while offering first of a kind modularity for walls and ceilings with unmatched strength, stability, and structural support.

As seen in FIGS. 8B, 8C, and 8F-H, in some embodiments, structural panels 1100 may comprise an outer face 1110, an inner face 1120, and edges 1130. Structural panels 1100 may be substantially rectangular having four edges 1130. Structural panels 1100 may be configured with side walls 1131 at each edge 1130 wherein a first wall section 1132 extends substantially perpendicularly from outer face 1110 toward inner face 1120, and wherein a second wall section 1133 extends substantially parallel to the panel's faces from said first wall section 1132 toward an edge 1130 substantially opposite side wall 1131 relative inner face 1110.

Further, a plurality of apertures 1134 may be disposed along each side wall 1131. A first set of apertures 1135 of plurality of apertures 1134 may be disposed along first wall section 1132. A second set of apertures 1136 of plurality of apertures 1134 may be disposed along second wall section 1133. A first wall section 1132 may be adapted to attach to or otherwise engage with one or more other first wall sections 1132 or second wall sections 1133 via respective apertures disposed along each. A second wall section 1133 may be adapted to attach to or otherwise engage with one or more other second wall sections 1133 or first wall sections 1132 via respective apertures disposed along each. Wall sections 1132 and 1133 may be engaged via conventional means capable of securely retaining one section to the other.

Depicted in FIG. 10, structural panel 1100 may be fabricated according to a pattern having side walls 1131 being initially flat extending away from edges 1130. After shaping consistent with the pattern, first wall section 1132 may be formed by bending the section toward inner face 1120 until the section is substantially perpendicular to the panel's faces. Second wall section 1133 may be formed by bending the section toward an edge 1130 positioned substantially opposite the section relative inner face 1120 until the section is substantially parallel to inner face 1120.

This double bend involves folding the material on each edge of the panel's ultimately rectangular form twice to create two potential connection surfaces along each edge-one for laterally positioned panels and one for connections directly to the inner face of the panel.

Because of the double bend and hole spacing, the panels may interchangeably connect walls panels to wall panels, ceilings panels to ceilings panel, walls to ceilings, etc. This not only creates flexibility but significant structural strength. Further, the second bend is the portion of the panels that would be flat against a piece of cardboard should it be held against this wall. For example, if a piece of sheetrock were hung on a wall comprising one or more structural panels, the second bend would be the flat piece that the sheetrock would hang against. Conventional designs on the market do not have this second bend that enables delivery of such secure shelters at scale. A comparison of conventional designs and a design in accordance with embodiments of the present disclosure is shown by FIGS. 8D, 8E, 9A, and 9B. Seen in FIG. 8D, conventional designs require use of specialized ceiling, corner, and wall components which is entirely avoided by embodiments of the present disclosure.

The additional bends create reinforced structural integrity, making the panels more resistant to impact and external forces. The design distributes stress more evenly, reducing weak points and ensuring a stable, secure structure even under extreme conditions. Double bends add stiffness to the panels, minimizing flex and improving the overall durability of the secure shelter. The precision of the double-bend process ensures tighter, more secure seams, enhancing both aesthetics and performance. By optimizing the panel's design for strength and functionality, it works seamlessly with other finish out surface components by providing a flat mounting surface on every wall/ceiling for finish out such as dry wall, gun racks, ship lap, etc.

In certain embodiments, structural panels 1100 may be formed from 3/16-inch A36 steel with protective industrial grade scratch resistant, corrosion resistant powder coating available in various colors including gun metal gray.

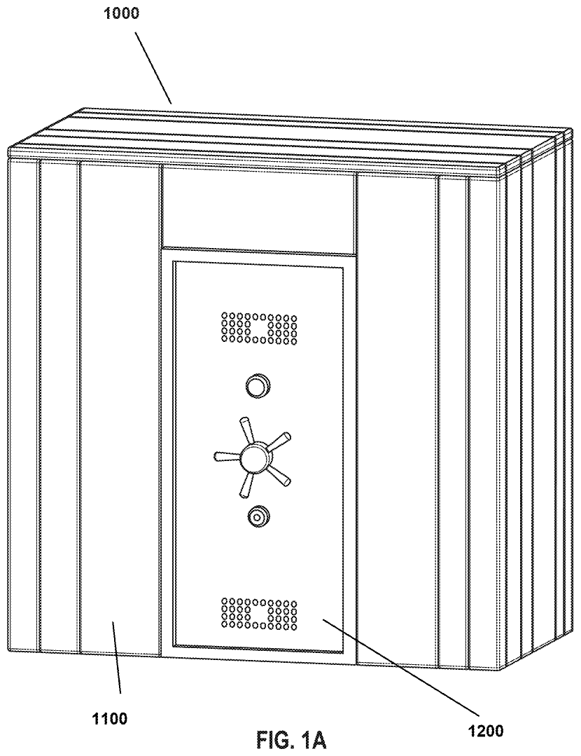

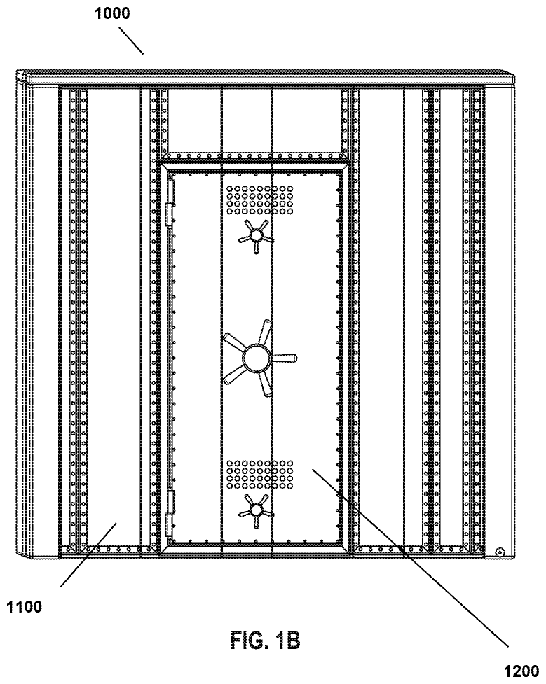

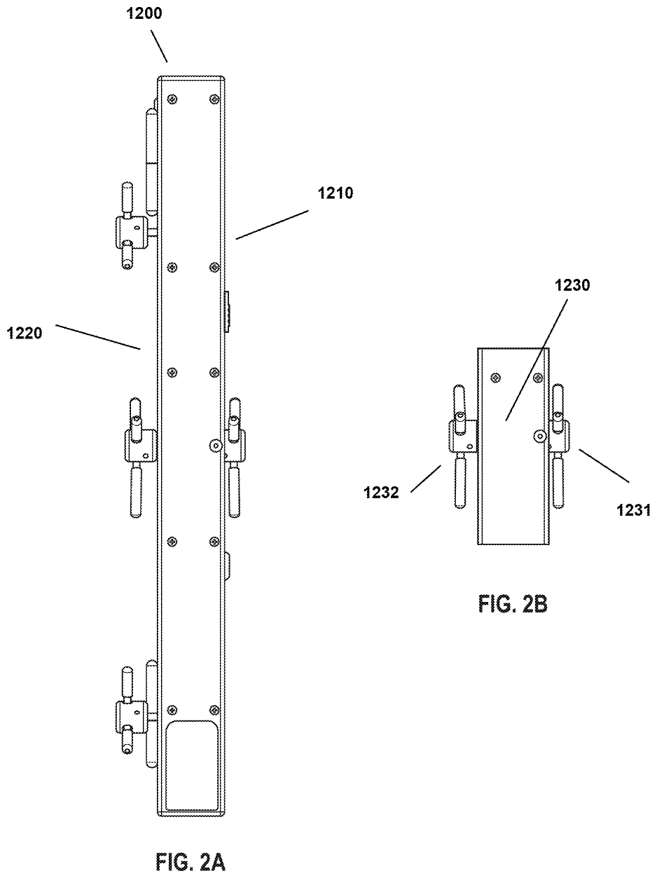

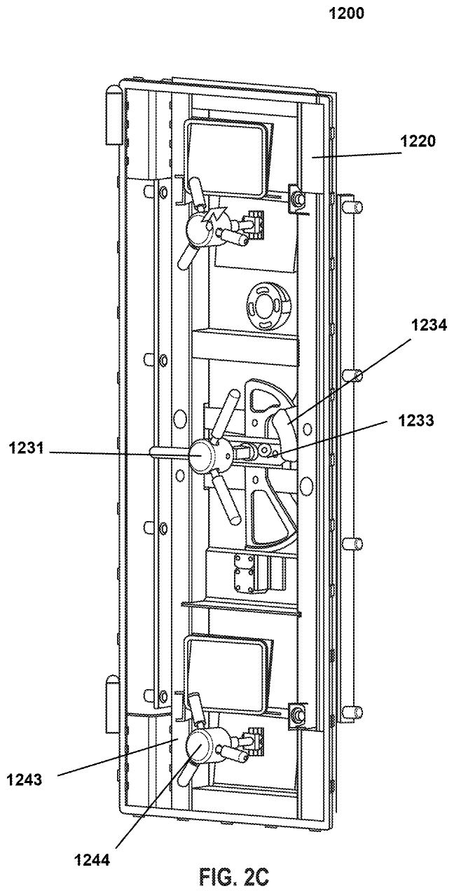

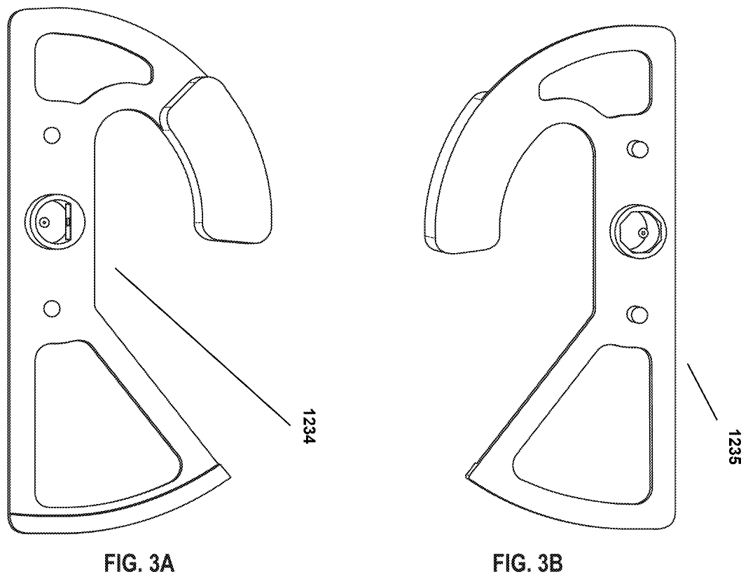

Seen in FIGS. 1A, 1B, 8A, 8E, and 81-K, security shelter 1000 may be composed of a plurality of structural panels 1100 arranged in a substantially box-like shape with dimensions based on a user's preference. Structural panels 1100 may be substantially identical or differ in length and width to accommodate a user's preference. Structural panels 1100 may be adapted to attach to or otherwise engage with a door frame adapted to receive secure door 1200. The frame may be made of steel or other suitable material and configured to attach to or engage with structural panels 1100 via conventional means.

A secure door 1200 in accordance with embodiments of the present disclosure features a single-action mechanism for engaging eight one-inch-thick robust steel slide bolts, a double-walled door design for enhanced protection, and active or sealed ventilation controls. The double-walled design provides superior protection against external threats, impacts, and unauthorized entry. The door may also incorporate modern digital keyless entry technology with a redundant mechanical override system to ensure access and usability in all conditions and critical situations. Secure door 1200 may comprise exterior layer 1210, interior layer 1220, locking assembly 1230, one or more ventilation assemblies 1240, Secure door 1200 may also comprise a keypad 1250.

Locking assembly 1230 may comprise an interior actuator 1231, an exterior actuator 1232, and engagement assembly 1233. Interior actuator 1231 may be disposed on interior layer 1220 and be configured to actuate locking mechanism 1230 from within a secure shelter 1000. Exterior actuator 1232 may be disposed on exterior layer 1210 and be configured to actuate locking mechanism 1230 from outside a secure shelter 1000. Actuators 1231 and 1232 may be vault wheels or other conventional structures capable of interfacing with and actuating an interior facing lock driver 1234 and exterior facing lock driver 1235, respectively. In some embodiments, lock drivers 1234 and 1235 are formed as seen in FIGS. 3A and 3B, respectively.

In further embodiments, interior actuator 1231 is further configured to disengage exterior actuator 1232 from exterior facing lock driver 1235 when interior actuator 1231 is pulled inward toward the interior of a secure shelter 1000. When pushed outward, interior actuator 1231 may engage, or re-engage, exterior actuator 1232 with exterior facing lock driver 1235.

As shown in the drawings, lock drivers 1234 and 1235 may comprise an aperture adapted to accommodate a substantially octagonal structure (though other shapes or similar functional structures could be used) formed along the rotational axis of actuators 1231 and 1232. Upon pulling of interior actuator 1231 toward the interior of a secure shelter 1000, the substantially octagonal structure arranged for engagement in a corresponding aperture of exterior facing lock driver 1235 is configured to become disengaged from exterior facing lock driver 1235 thereby preventing actuation of locking mechanism 1230 by exterior actuator 1232.

In some embodiments, locking assembly 1230 creates a single-action mechanism that engages eight one-inch-thick steel slide bolts with a single twist of the handle. When locked from inside the room, the locking mechanism disengages all control from the outside of the room allowing occupants inside the room to always retain final control of all critical functions for ultimate security and peace of mind. This robust locking system ensures a secure closure, preventing forced entry, and eliminates the need for multiple manual actions to secure the door.

Lock drivers 1235 and 1234 are connected to the exterior and interior vault door handles, respectively. By pulling the interior handle toward the inside of the room, the octagon shape is disengaged from the vault door's exterior handle. By doing so, all access from this point forward is controlled by the operator inside the room. When the handle is pushed toward the outside of the door, the octagon re-engages with the exterior handle making both handles fully operable again.

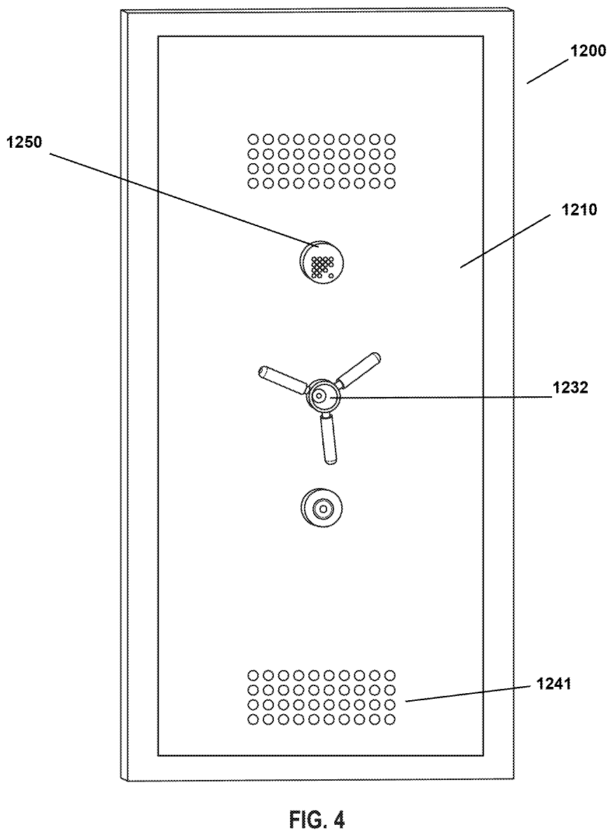

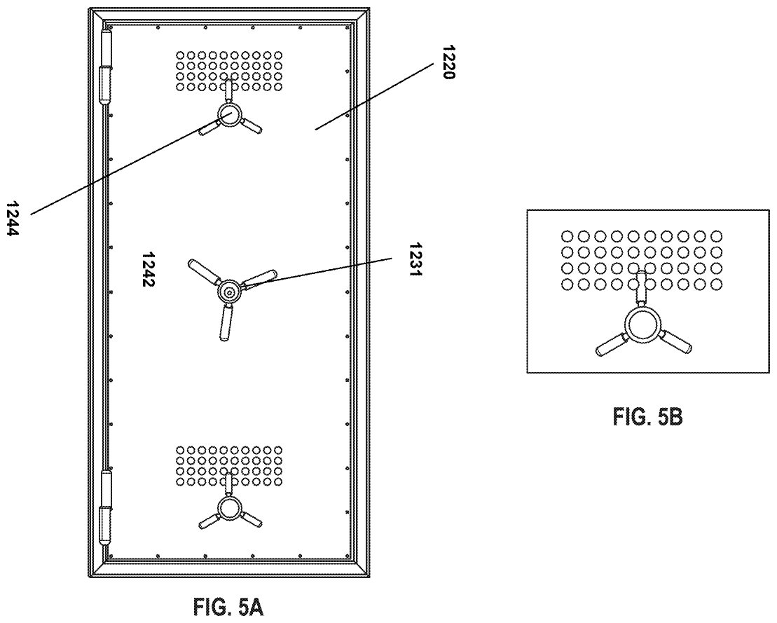

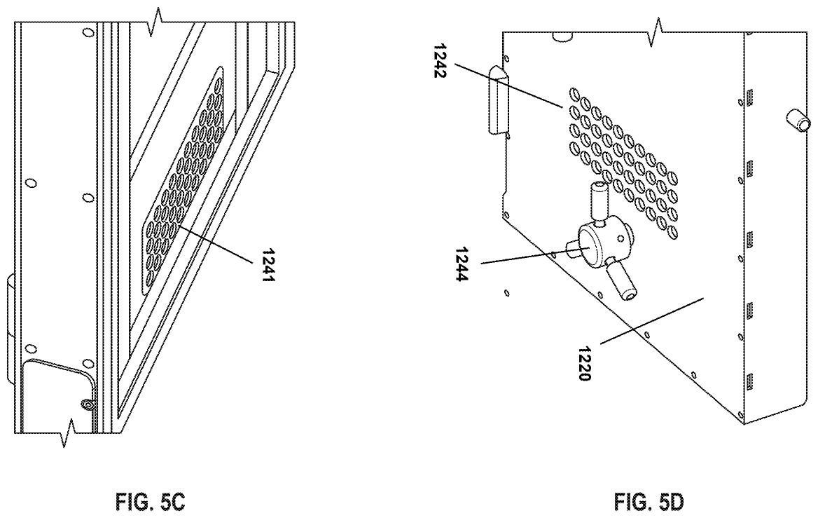

Seen in FIG. 4, an inward-swinging, sealed perimeter of secure door 1200 is designed to provide a tight seal around the door's edge to protect against external forces, debris blockage, and tampering.

Secure door 1200 may also feature a modern digital keyless entry system 1250 offering secure access without the need for physical keys. In addition, the door may be equipped with a redundant mechanical override that ensures the door can still be opened manually in the event of a power failure or system malfunction.

Exemplary specifications of a secure door 1200 are as follows: 3/16-inch A36 steel with protective industrial grade scratch-resistant and corrosion-resistant powder coating available in various colors including gun metal gray; 24″ or 32″ wide, left or right swinging door; double walled for increased security from all external threats; inward swinging; heavy duty 360-degree barrel hinges allowing door to swing fully inward to maximized space within shelter; continuous door stop for a completely sealed and secure finish; dormakaba high-security redundant locking system (both digital and mechanical access features for redundancy); 8 solid steel locking pins, all controlled with a single captain's wheel action; controllable and integrated ventilation; and single action captain's wheel allowing occupants of the secure shelter to always retain final control of all critical functions for ultimate security and peace of mind.

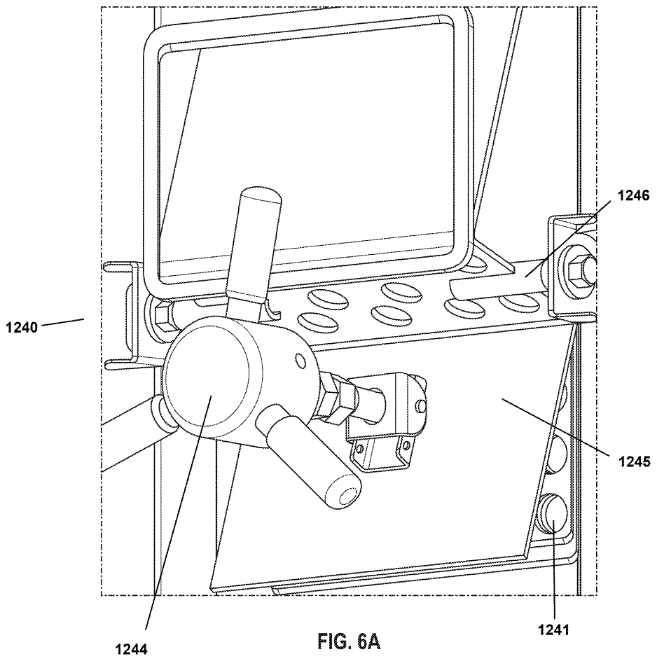

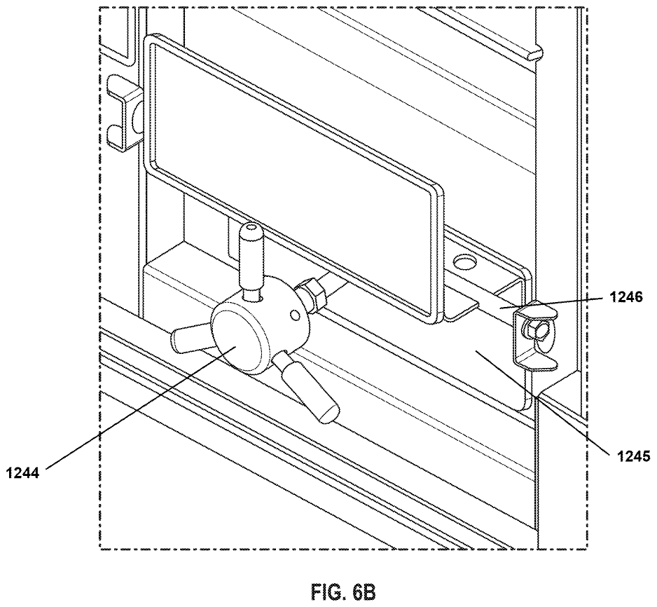

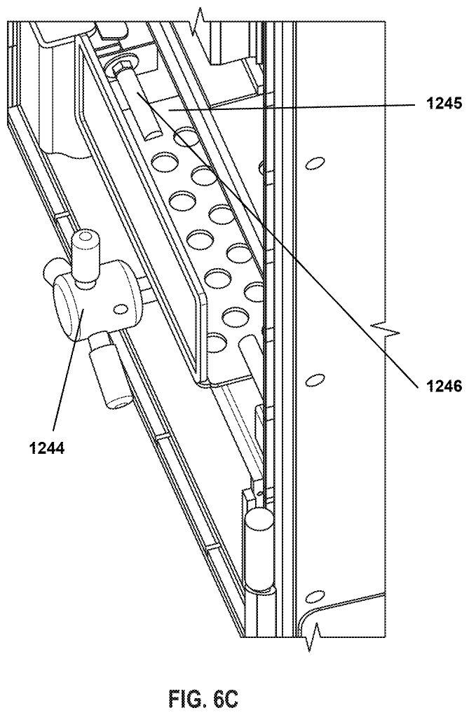

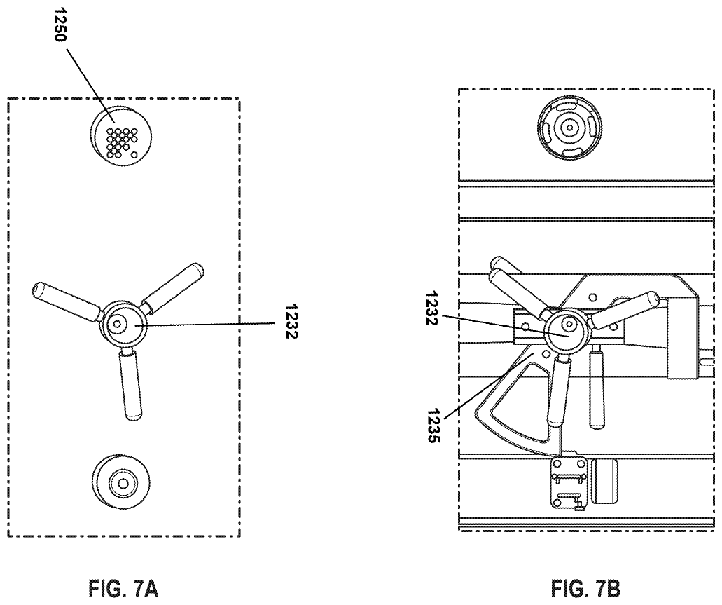

Secure door 1200 may further incorporate an advanced ventilation control system 1240, which can be set to either active or sealed modes. Ventilation assembly 1240 may comprise exterior-layer ventilation apertures 1241, interior-layer ventilation apertures 1242, and ventilation actuation assembly 1243. Ventilation actuation assembly 1243 may comprise a vent actuator 1244, vent cover 1245, and rotator 1246. In some embodiments, vent cover 1245 is configured in a substantially “Z”-shaped design wherein two portions of solid material are positioned around and extending from a central portion having ventilation apertures disposed therein as seen in FIGS. 6A-C. Vent cover 1245 may be formed from a single material, and the angles between portions may be substantially ninety degrees in some embodiments. Rotator 1246 may be one or more pivot hinges configured to permit vent cover 1245 to rotate, at least in part, around an axis when actuator 1244 is used. Actuator 1244 may be similar to the secure room locking assembly actuators (captain's wheel, hub/spokes, etc.) or be another conventional structure capable causing vent cover 1245 to rotate around rotator 1246. In some embodiments, actuator 1244 may be attached to, or otherwise engaged with, vent cover 1245 whereby actuation causes vent cover 1245 to move forward and/or backward resulting in rotation around the axis partially defined by rotator 1246.

In active mode, the ventilation system 1240 allows airflow while preventing the entry of debris or environmental threats. In sealed mode, the system ensures complete isolation of the vault from external conditions, maintaining the integrity of the secure space. Conventional doors lack the ability to cause both complete sealing off from all exterior elements (airflow, dust, particles, etc.) and venting to allow full air flow.

This airflow may be accomplished by having numerous holes that are each 1″ in diameter cut into the inner and outer door layers. Exemplary 24″ & 32″ doors in accordance with this disclosure may have a total hole count of 96 (on 24″ door) and 160 (on 32″ door) when combining the inner and outer steel layers.

The inner and outer 1″ ventilation holes are placed with outer holes 1241 always being lower than inner holes 1242. The reason for this is that objects drop as they travel through the air. If an object is able to pass through any of the exterior 1″ holes, there are two additional layers of protection (steel plate vent covering the inner holes and the inner door layer itself) to protect the occupants.

Complete sealing may be accomplished in at least two ways. The exterior perimeter is completely sealed with zero airgaps when the door is in the closed position. Shelters in accordance with the present disclosure have designed a Z-plate and pivot concept which allows for a threaded mechanism to either be turned right into a sealed/closed position or turned left into an unsealed/active position. The Z-plate design may be a single piece of 3/16″ steel with a pivot hinge allowing for all vent holes to be either sealed shut or opened by simply turning the ventilation actuator (hub/spokes) right or left respectively.

In some embodiments, secure shelter 1000 may feature one or more ventilation assemblies 1240. As depicted in the figures, in such embodiments, one such assembly may be positioned near the top of secure door 1200 and another near the bottom of secure door 1200.

The section headings herein are provided for consistency with the suggestions under 37 C.F.R. § 1.77 or to provide organizational cues. These headings shall not limit or characterize the invention(s) set out in any claims that may issue from this disclosure. Further, a description of a technology as background information is not to be construed as an admission that particular technology is prior art to any embodiment(s) in this disclosure. Neither is the “Summary” a characterization of the embodiment(s) outlined in issued claims.

Furthermore, any reference in this disclosure to “invention” or “embodiment” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A secure shelter comprising:
a plurality of structural panels configured for engagement with each other, wherein said plurality of structural panels have an outer face, an inner face, and a plurality of edges, wherein each edge of said plurality of edges comprises a side wall having a first wall section and second wall section, wherein said first wall section extends from said outer face and runs substantially perpendicular to said outer face, wherein said second wall section extends from said first wall section toward said inner face and runs substantially parallel from said outer face;
a plurality of engagement apertures formed into said side wall for each said edge, wherein a first set of said plurality of engagement apertures is formed into said first wall section, and wherein a second set of said plurality of engagement apertures is formed into said second wall section;
a secure door comprising a frame securely attached to one or more of said plurality of structural panels, said steel door further comprising a door member configured to be received by said frame.

2. The secure shelter of claim 1 wherein said secure door further comprises an outer layer, an inner layer, and a locking assembly, wherein said locking assembly comprises an interior actuator configured to engage with an interior-facing lock driver, wherein said locking assembly further comprises an exterior actuator configured to engage with an exterior-facing lock driver.

3. The secure shelter of claim 2 wherein said interior actuator is further configured to cause said exterior actuator to be disengaged from said exterior-facing lock driver when said interior actuator is pulled.

4. The secure shelter of claim 3 wherein said secure door further comprises a ventilation assembly having exterior-facing ventilation apertures, interior-facing ventilation apertures, and a ventilation actuation assembly.

5. The secure shelter of claim 4 wherein said ventilation actuation assembly comprises a vent actuator, a vent cover, and a rotator.

6. The secure shelter of claim 5 wherein said vent cover is a substantially flat material formed into substantially a Z-shape, wherein said vent cover is disposed such that it may partially rotate around said rotator.

7. The secure shelter of claim 6 wherein said rotator is a pivot hinge.

8. The secure shelter of claim 7 wherein said exterior-facing apertures are formed into said outer layer, and said interior-facing apertures are formed into said inner layer.

9. The secure shelter of claim 8 wherein said exterior-facing apertures are positioned higher than said interior-facing apertures.

10. The secure shelter of claim 9 wherein said plurality of structural panels are arranged in a substantially room-like configuration.

11. A secure shelter comprising:
a room comprising a plurality of structural panels engaged to each other, wherein said plurality of structural panels have an outer face, an inner face, and a plurality of edges, wherein each edge of said plurality of edges comprises a side wall having a first wall section and second wall section, wherein said first wall section extends from said outer face and runs substantially perpendicular to said outer face, wherein said second wall section extends from said first wall section toward said inner face and runs substantially parallel from said outer face; and
a secure door comprising a frame securely attached to one or more of said plurality of structural panels, said steel door further comprising a door member configured to be received by said frame.

22. The secure shelter of claim 11 wherein said secure door further comprises an outer layer, an inner layer, and a locking assembly, wherein said locking assembly comprises an interior actuator configured to engage with an interior-facing lock driver, wherein said locking assembly further comprises an exterior actuator configured to engage with an exterior-facing lock driver.

13. The secure shelter of claim 12 wherein said interior actuator is further configured to cause said exterior actuator to be disengaged from said exterior-facing lock driver when said interior actuator is pulled.

14. The secure shelter of claim 13 wherein said secure door further comprises a ventilation assembly having exterior-facing ventilation apertures, interior-facing ventilation apertures, and a ventilation actuation assembly.

15. The secure shelter of claim 14 wherein said ventilation actuation assembly comprises a vent actuator, a vent cover, and a rotator.

16. The secure shelter of claim 15 wherein said vent cover is a substantially flat material formed into substantially a Z-shape, wherein said vent cover is disposed such that it may partially rotate around said rotator.

17. The secure shelter of claim 16 wherein said rotator is a pivot hinge.

18. The secure shelter of claim 17 wherein said exterior-facing apertures are formed into said outer layer, and said interior-facing apertures are formed into said inner layer.

19. The secure shelter of claim 18 wherein said exterior-facing apertures are positioned higher than said interior-facing apertures.
